(19) United States
(12) Patent Application Publication
(10) Pub. No.: US 2006/0286512 A1
(43) Pub. Date: Dec. 21, 2006

(54) Computerized system for designing a pattern to be applied to a doll or toy

(76) Inventors: Mary Ann Cogliano, Santa Rosa, CA (US); Victoria Leigh Cogliano, Santa Rosa, CA (US)

Correspondence Address: HOFFMAN, WASSON & GITLER, P.C.;Crystal Center 2, Suite 522, 2461 South Clark Street, Arlington, VA, 22202, US

(21) Appl. No.: 11/154,708

(22) Filed: Jun. 17, 2005

(51) Int. Cl. G09B 19/20

(52) U.S. Cl. 434/95

(57) ABSTRACT

A method, system and kit for allowing a user to produce a particular design for clothing. The user would have the opportunity of customizing a particular design, including ornamentation and accessories on a computer. Once the particular design has been completed, a printer would print the pattern which would then be applied to a fabric blank. The pattern could include all of the ornamentation and accessories, or, in the alternative, would allow the user to include the ornamentation and accessories themselves. Once that is completed, the design pattern is applied to a doll, stuffed animal, or the like.

### FIELD OF THE INVENTION

The present invention relates to a toy kit utilizing a computer to generate a pattern to be applied to a toy, such as a doll or stuffed animal.

### BACKGROUND OF THE INVENTION

There is no doubt that we are currently living in a computerized world. Since the advent of the personal computer, approximately twenty years ago, computers have found their way into every facet of our lives. Computers in the form of a standard personal computer, laptop, or portable “Blackberry” type device allow us to communicate with other individuals on an instantaneous basis. Computers are also utilized in conjunction with the internet to search for information provided on various web sites as well as to share information with other users in a peer-to-peer basis.

Additionally, computers have been utilized to control the activation of various appliances in one's home, either on an automatic basis or by remotely activating these computer controlled devices. Furthermore, computers have found their way into the vehicles that we drive with the operation as well as the navigation of many modern vehicles controlled by a computerized chip.

While computers have undoubtedly made the average person's life much easier, when it comes to utilizing a computer to entertain a child, the computer entertainment industry has come under attack for changing the manner in which children entertain themselves, to the detriment of a child's ability to amuse themselves in a traditional manner, when computers were not in vogue, as well as to interact with other children. Many times, a child would spend countless hours in front of a computer screen utilizing a keyboard or other input device to play either an individual or interactive computer game. The child would sit for hours in front of a computer screen hitting various buttons or other input devices without the necessity of utilizing the child's imagination or creativity during the play of the game.

Historically, prior to the advent of the computer used as an entertainment medium, children would use their imagination while they were engaged in play with their friends or would utilize various inanimate objects, such as dolls or stuffed toys. One example of such play, particularly for girls, would be the famous Barbie® doll produced by Mattel. When purchased, the original Barbie® doll would come with several outfits to be worn by the Barbie® doll, as well as a number of accessories. Additional outfits and accessories could be purchased separately. Thereafter, in play, the child would utilize its imagination to interact with other children and their dolls to create a particular environment of play. Based upon a scenario created by the children, various outfits or accessories would be worn. However, one drawback of this type of play would be that the child would be limited to the particular outfits or accessories which would then be applied to the doll. While the imagination of the child would be tapped during this type of play, relatively little creativity would be required of a child to produce original outfits or accessories.

As previously indicated, the computer industry has generated some negative publicity relating to the lack of imagination or creativity utilized during the primarily sedentary manner in which most computer games are played. However, when employed properly, the standard personal computer can have many beneficial attributes which would assist in utilizing a child's imagination and creativity during the play of a particular game or activity, particularly when this game or activity also includes the use of a non-computer generated inanimate object, such as a doll or a stuffed animal, as well as a computer generated pattern which can be utilized to produce a piece of clothing to be applied to the doll or stuffed animal.

U.S. Pat. No. 4,873,643 to Powell shows an interactive design terminal for custom imprinted articles. The terminal includes a central processing unit 110, a manual input device 130, a video display 140, a dot matrix printer 151 as well as a laser printer 152. The interactive design terminal presents an ordered sequence of printed design choices to an operator via the video display 140. A display of the selections made by the operator can be shown as a graphic display. The laser printer 152 can provide a silk screen for imprinting a garment, such as is shown in FIG. 4. FIG. 4 includes a selection menu display 400 for selecting an arrangement of lines of text. The menu selection display 400 includes a plurality of samples 401-405 illustrating permitted combinations of text line arrangements relative to a central portion of a garment. Although the operator is allowed to choose various types of garments such as a short sleeved T-shirt, a long sleeve T-sheet, a sweatshirt or the like, as well as a selected garment color, no provision is made for altering the style of the type of garment chosen, such as adding accessories to that garment, such as beads or fur, as well as altering the basic make-up of the garment, such as adding a plunging neckline, or shortening a skirt, as well as adding various ornamental designs to the surface of the garment.

U.S. Pat. No. 4,949,286 to Ohba describes a dress design forming apparatus for interactively generating and visually displaying free curved surfaces for use in dress designing. As shown in FIG. 29, various patterns are displayed in a pattern display unit 16, which could also be plotted on a figure surface by a plotter 17. A paper pattern forming section 20 including a television camera 21 would take a picture of the paper pattern 22 which would be used to display a dress image on screen 43. While the patent to Ohba does employ a computer to illustrate how a particular dress design initially provided on a two-dimensional plane would be depicted as a three-dimensional shape of a dress when tailored, no printer is utilized to actually produce the two-dimensional dress pattern. Furthermore, no accommodation is made to add various accouterments to the finished dress pattern.

U.S. Pat. No. 4,539,585 issued to Spackova et al. describes a previewer used for the dynamic viewing of an article to be worn by the user. A video camera 13 would take a picture of the user and through the use of a computer 20, an image storage memory 25, as well as a monitor 16, the viewer would be able to preview the manner in which a particular style of clothing would look on the user. It is noted that no printer is utilized to produce a pattern of the clothing shown on the video screen and no provision is made to alter a particular basic pattern.

U.S. Pat. No. 4,149,246 issued to Goldman illustrates a system for specifying custom garments. A garment is produced which is related and scaled to a wearer's physical data. Terminal equipment includes an interactive graphics apparatus for developing the garment as well as providing various options for the garment. Once the finished garment is produced and is included on a terminal to be viewed by the wearer, the garment is transmitted to a central location unit for use in cutting a pattern for the garment's production. While various options can be utilized in the production of the pattern, no provision is made for allowing the garment to be sized to the dimension of a child's doll or stuffed animal.

U.S. Pat. No. 5,937,081 issued to O'Brill et al. discusses an image composition system allowing a customer to see how a particular style of clothing would be visualized by the customer. A camera 40 coupled to a central processing unit 30 would store the digital image of the customer. The customer's image 23, along with a particular style of clothing as well as accessory items would be generated on a monitor 20. While the system of the O'Brill et al. patent would allow a customer to create various styles, including accessories and allow the customer to view the produced clothing on a digital image of the customer, no provision is made for providing a pattern of the clothing, including the accessory items as well as allowing the clothing to be sized for a doll or a stuffed animal in a manner such that the pattern could be applied to the doll or stuffed animal.

U.S. Pat. No. 6,280,283 issued to Sisler describes a doll kit initially provided with a blank form allowing a child to apply various features to the blank. This blank form can take the form of a humanoid, as well as an animal. However, the child is not given the opportunity to actually design a particular piece of clothing to be worn by the doll or stuffed animal. More precisely, as shown particularly in FIGS. 2 and 3, a plurality of facial features are applied to the doll's head or a stuffed animal's head to alter the appearance of the doll or stuffed animal, in a manner similar to the famous “Mr. Potato Head” kit and game.

U.S. Pat. No. 4,168,592 issued to Merino describes a kit including a doll onto which various clothes can be attached. The doll is provided with a plurality of slots which are used to affix a two-dimensional fabric clothing piece to the doll. However, similar to the doll kit shown in the patent to Sisler, no provision is made for allowing the child to design the particular dress worn by the doll.

### SUMMARY OF THE INVENTION

The problems and the deficiencies of the prior art are addressed by the present invention which utilizes a computer generated pattern in conjunction with a toy kit, allowing a child to employ his or her imagination to produce a particular style of clothing as well as to accessorize the clothing.

A plurality of clothing patterns, as well as accessories used with the clothing patterns, would be included on a removable memory associated with the computer. Alternatively, the various clothing designs, as well as accessories, would be included in a memory accessed by the user over the internet.

The user would have the ability to customize a particular design pattern, including changing the basic design of the pattern, adding various colors or designs to the body of the pattern, as well as adding various accessories, such as beading or fur trim to various portions of the design. Once a particular piece of clothing has been designed by the user, a printer associated with the computer would produce a basic pattern of the design. This basic pattern would include the basic shape of the pattern. Additional features such as the ornamental design of the pattern, including, for example, a series of polka dots, stripes or the like, as well as the location of various accessories to be applied, for example, to the hem of a dress pattern, could be included on the basic pattern.

The present invention could utilize a mannequin, in the shape of a humanoid, as well as other forms, such as stuffed animals, or even a paper doll. One or more cloth pieces would be included in the kit. These cloth pieces would be cut to the dimensions of the pattern. If the pattern, for example, was in the form of a dress, this pattern would be traced upon the cloth pieces. The child would then cut the cloth based upon the tracing. When used with mannequins or stuffed animals, the child would then glue the seam together as well as have the ability to color the pattern as well as to apply the various accessories as well as the ornamental pattern, such as stars, polka dots or the like to the cloth, either after the seam is glued in the manner to form the particular piece of clothing or prior to this step. At this point, the piece of clothing can be applied to the mannequin. Based upon the type of cloth utilized, the child might have the ability to remove both the colored ornamental design of the piece of clothing as well as the accessories. The child would then have the ability to change the appearance of the pattern.

A digital camera in communication with the computer could be used to customize the pattern further. For example, a picture can be taken of the child which would be used in conjunction with a figure displayed on the computer screen. This picture could include the child's face, allowing the child to view the pattern as if the child himself or herself was modeling the pattern.

### BRIEF DESCRIPTION OF THE DRAWINGS

A fuller understanding of the present invention and the features and benefits thereof, will be accomplished upon review of the following detailed description together with the accompanying drawings, in which:

FIG. 1 is a block diagram of a computer system;

FIG. 2 is a block diagram of a typical input device shown in FIG. 1;

FIG. 3 is a drawing of a computer screen showing a basic two-dimensional pattern thereon;

FIG. 4 is a drawing of a computer screen showing a two-dimensional pattern provided with accessories;

FIG. 5 is a drawing of a computer screen showing a three-dimensional rendition of the pattern of FIG. 4 provided on a human form;

FIG. 6 is a drawing of a mannequin having the pattern of FIG. 5 thereon;

FIG. 7 is a drawing of a stuffed animal onto which a pattern can be placed; and

FIG. 8 is a block diagram showing the steps of the method according to the present invention.

### DESCRIPTION OF THE PREFERRED EMBODIMENT

The present invention is directed to a system and method allowing a child to create a particular design for a piece of clothing. Although the present invention can be utilized for any type of clothing, for ease and simplicity of explanation, we will describe the present invention with respect to creating a particular design of a dress.

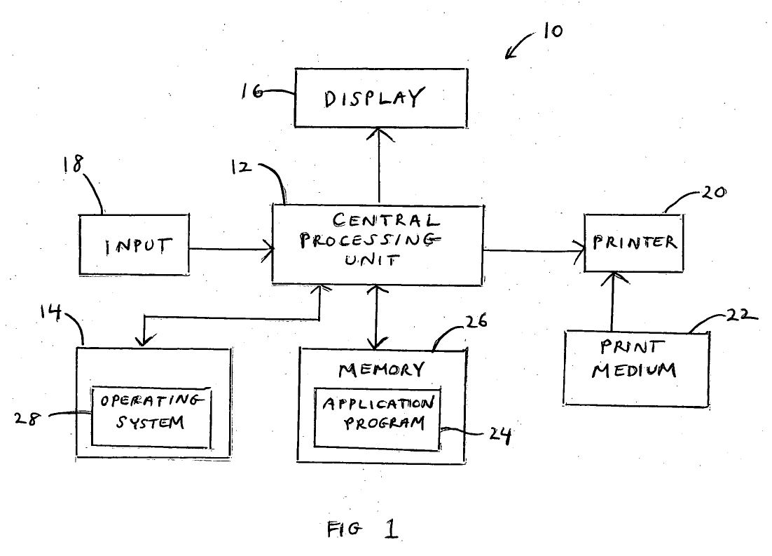

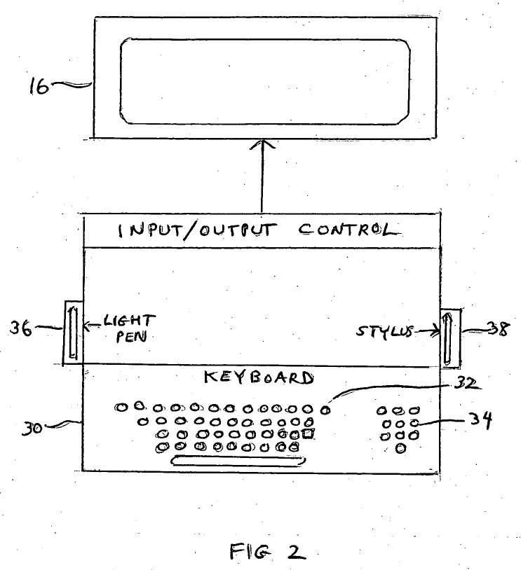

Initially, the dress will be designed utilizing a standard personal computer system 10 as illustrated with respect to FIG. 1. The computer system 10 is a standard personal computer, or, in the alternative, the present invention can be practiced with respect to a laptop computer. In both instances, a central processing unit 12 would be in communication with a display device 16, such as a standard monitor. An input device 18 is also in direct connection with the central processing unit 12. This input device 18 will be illustrated more particularly with respect to FIG. 2. However, it is important to note that any standard input device, such as a mouse or keyboard, or any other type of input device, would be suitable to be utilized with respect to the present invention. The input device 18 would be connected to the central processing unit 12 by either a wired or wireless connection. This central processing unit 12 would be provided with a memory 14 including an operating system 28 as well as a memory 26 including an applications program 24. It is noted that although these memories 14 and 26 are illustrated separately in FIG. 1, they both can be combined into a single memory unit.

The operating system 28 would be utilized to operate the computer system 10 with the assistance of an application program 24 specific to the application of the present invention. Particular with respect to the application program 24, this program is generally provided on a CD-ROM which can be inserted into the central processing unit 12. This CD-ROM used as the applications program 24 would contain a multitude of design choices for different types of clothing, such as dresses, swimsuits, blouses, shirts, skirts, pants, and the like. It would also allow various colors, as well as designs, to be displayed on the exterior of the piece of clothing, in this case a dress. Furthermore, the applications program 24 would allow the basic design pattern to be altered utilizing any one of a multitude of input devices 18. The application program 24 would also allow various accessories to be added to the basic dress pattern.

Additions to the basic dress pattern would generally be made to a two-dimensional representation of the dress pattern appearing on the display 16. Once the dress pattern is completed, the computer system utilized by the present invention would allow this pattern to be displayed on a three-dimensional representation of a mannequin, stuffed animal or the like. At this point, the user would have the opportunity to make additional changes to the pattern either on the three-dimensional representation of the mannequin or the user can revert to the two-dimensional layout. Once the pattern is completed to the satisfaction of the user, a printer 20 would be utilized in conjunction with a print medium 22 to physically produce a representation of the pattern created by the user. While it is possible that the pattern printed on the print medium 22 would be a complete duplication, including color, design changes, as well as accessories created by the user, it is also possible that the pattern printed on the print medium 22 would only be a partial representation of the completed pattern. This partial representation would still have enough information to allow a child to physically produce the dress pattern utilizing the various implements of the kit of the present invention, as well as additional implements. This process will be explained in greater detail hereinbelow.

Referring to FIG. 2, various types of input devices can be used to allow a user, with the aid of the computer, to produce an image on the display 16. For example, the input device could include a standard keyboard 30 with a first set of entry keys 32 and a second set of entry keys 34 allowing the individual to call-up various menus which will be utilized to choose a particular design, alter that design by changing various dimensions or facets, producing a particular color for the design as well as allowing the user to specify various design elements, such as, but not limited to, checks, stripes, polka dots and the like. Additionally, the user would be allowed to accessorize the design, such as the dress, by adding various features, such as beading, fur trim and the like. Although the various entry keys of the keyboard sections 32 and 34 can be utilized for all of these modifications, various other input devices, such as a light pen 36 and stylus 38 as well as a mouse (not shown) may also be utilized to change, or produce, a design shown on display screen 16.

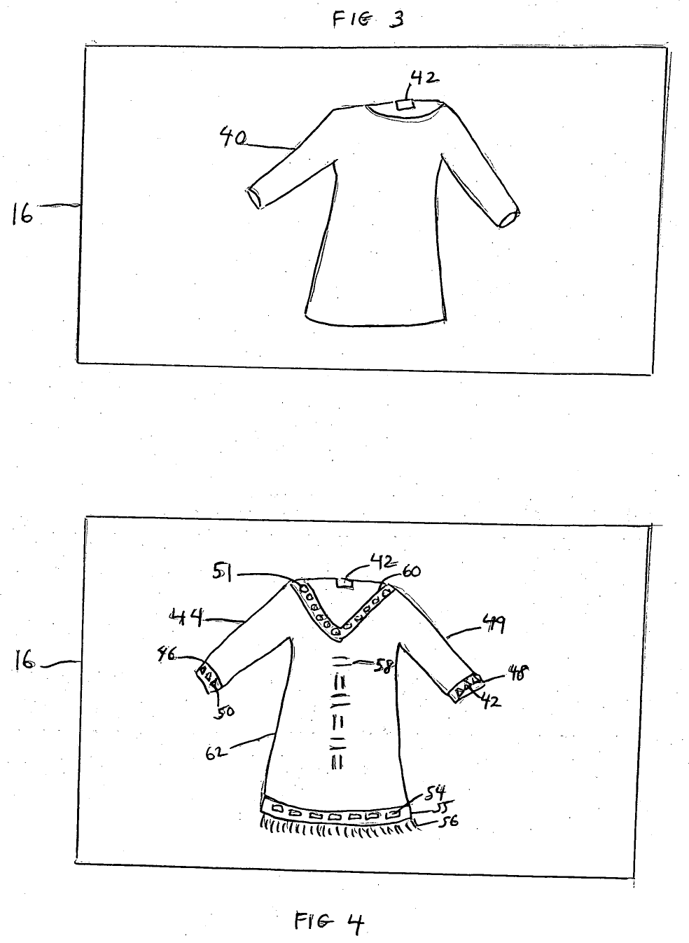

FIG. 3 illustrates the manner in which one of a multitude of design choices would be displayed upon the input device, such as a computer screen 16. As previously indicated, although many types of design choices, such as a dress, swimming suit, shirt, skirt, or the like, could be utilized, for ease of description, we will describe the present invention with respect to designing a particular dress pattern. Therefore, utilizing the particular application program, as well as memory as recited in FIG. 1, the user would have the ability to choose one of a number of design choices. As envisioned, the application program and memory would either be provided local to the computer, or alternatively, at a remote location, allowing the user access through the use of the internet. Through these memory devices, the user would be presented with a menu including the various design categories, such as a dress, swimsuit, shirt, skirt, or the like. Once the particular category, in this case a dress, is chosen, the user would have the opportunity to choose various types of, in this case, dresses. These different types of dresses would be displayed on the monitor screen 16 as either a menu having a multitude of written design choices, or, in the alternative, a plurality of design choices would be displayed on the screen 16. Once the user decides upon a basic pattern, and such a pattern is chosen, the basic pattern would be displayed on the computer screen, such as the dress 40 shown in FIG. 3. Additionally, this pattern would be provided with a tag 42 upon which the user can customize with his or her own “designer” label.

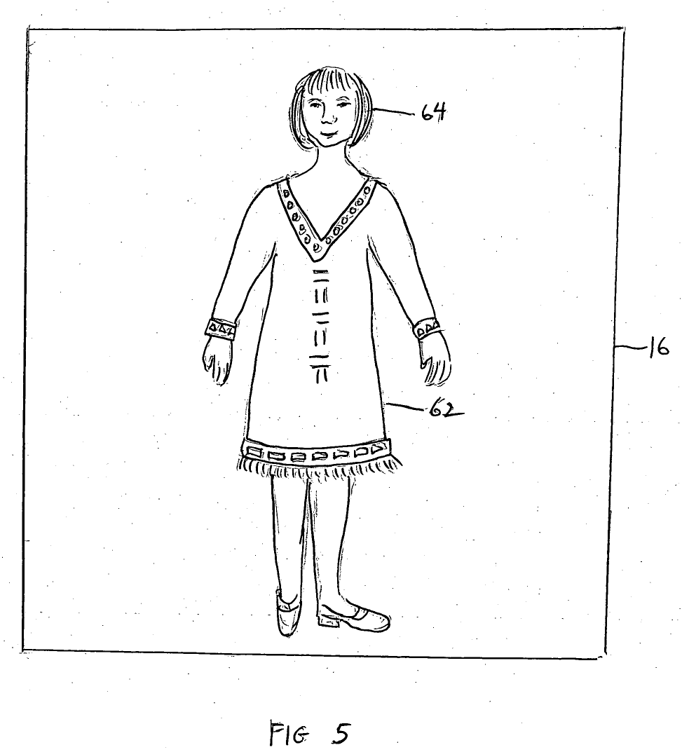

As shown in FIG. 3, the dress pattern 40 is projected as a two-dimensional pattern which can be changed by allowing the user to make various design choices. Some of these design choices are illustrated in the two-dimensional pattern design shown in FIG. 4. This figure illustrates a two-dimensional dress pattern created by the user employing the various input devices which are standard in the art, some of which are illustrated in FIG. 2. Utilizing the applications program as well as the operating system shown in FIG. 1, the user is given the opportunity to make various design choices to the standard dress pattern initially appearing in FIG. 3. Although we shall describe the manner in which one can proceed in producing the finished two-dimensional design shown in FIG. 4, it can be appreciated that the sequential order of these steps can be varied.

Once the basic pattern 40 is projected onto the display device 16, several changes can be made to the basic design. For example, the length of the dress can be altered from one which might initially end at the knee when attached to a mannequin, as will be described hereinbelow, or the dress can end several inches above the knee, or several inches below the knee. Another of the multitude number of changes that can be made to the basic design pattern 40 is illustrated in FIG. 4 in which the neckline 60 plunges in a manner as shown therein. The user would also have the opportunity of displaying the dress shown in FIG. 4 in various colors on the monitor of the display screen 16. Additionally, the user would have the opportunity to electronically apply various design choices onto the surface of the dress. These design choices can be made by displaying a menu describing or illustrating the design choices. The user would then have the opportunity to place these various design choices onto the surface of the two-dimensional pattern shown in FIG. 4 in various locations. Alternatively, the user would have the ability to use his or her imagination to provide original design choices to be applied to various portions of the dress pattern. For example, as shown in FIG. 4, the cuffs 46, 52 of respective sleeves 44, 49 would include a particular design 50, 52 respectively. A similar, or different design, can be provided around the neckline 51. Yet another design 58 can extend for a particular length on the front of the dress design. Similarly, a similar or different design can be provided on the hem of the dress 54. The user would have the opportunity to designate, not only the type of design and the placement of the design, but the color of the design as well.

Once these ornamental designs are made, the user would have the opportunity to accessorize various portions of the dress, such as, adding beads or fur to various portions of the dress design. The dress shown in FIG. 4 has been accessorized through the use of a trimming 56. This trimming, or other accessorized items, can physically be added to the dress pattern, after the pattern has been printed and attached to a cloth fabric blank.

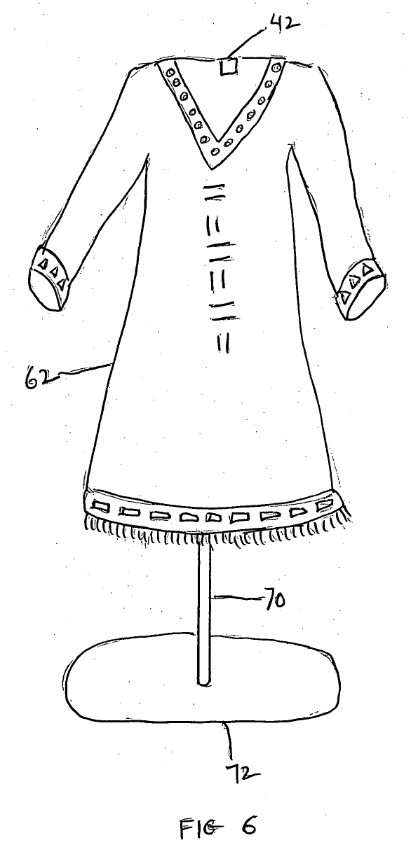

Once the user has completed his or her design, the user would have the opportunity to graphically display the dress on a doll or mannequin-like figure illustrated on the display screen 16. This doll-like FIG. 64 as shown in FIG. 5 would allow the user to view his or her handiwork as it would appear on the doll-like mannequin. This would give the user a final opportunity to alter the design in any way, i.e, by changing various design elements, accessories, or the main color of the dress. Therefore, once the dress pattern is completed to the satisfaction of the user, the pattern itself would be printed on the printer 20. The pattern, at the very least, would include the pattern 62. This pattern, printed by the printer 20 could include all of the elements of the design including ornamentation, color, as well as accessories shown in FIG. 4. Alternatively, the printed pattern design would include the location of some or all of the design elements and accessories with, at the very least, the location of these design elements and accessories. If this is the case, the user would then have the opportunity to physically place the design elements, as well as accessories themselves.

All of the final designs would be stored in a particular memory, allowing the user to recall these designs at a later time, for review or alterations. Some or all of these designs can be printed in a form allowing the user to produce a portfolio of these designs.

A further feature of the present invention would utilize a digital camera in communication with the computer to include the user's face in the doll-like figure shown in FIG. 5.

The print medium 22 which would be utilized to print the design pattern could be accomplished utilizing paper. If this was the case, and a color printer would be utilized, both the main color of the dress pattern, as well as the colors of the various ornamentation and accessories would be printed thereon.

Alternatively, the print medium could be more substantial than the previously described paper medium. This medium could be a relatively light plastic material. If this is the case, the pattern printed by the printer 20 might just include the dress design shown in FIG. 4 without any colorization and ornamentation or accessories, with the exception that the area that the accessories and ornamentation would be provided on the dress design would only be designated. In this instance, the user would have the opportunity to color the dress as well as the various ornamental designs. The user would also have the opportunity to physically attach various accessories, such as fur trim, ruffles or beading to the appropriate location or locations designated by the printed pattern with various implements. If the printed material of the pattern was washable, the user would then have the opportunity to wash off a particular color and re-color that design. The user would also have the opportunity to remove the ornamentation or accessories with the option of reapplying these ornamentations and accessories in different locations or in different manners.

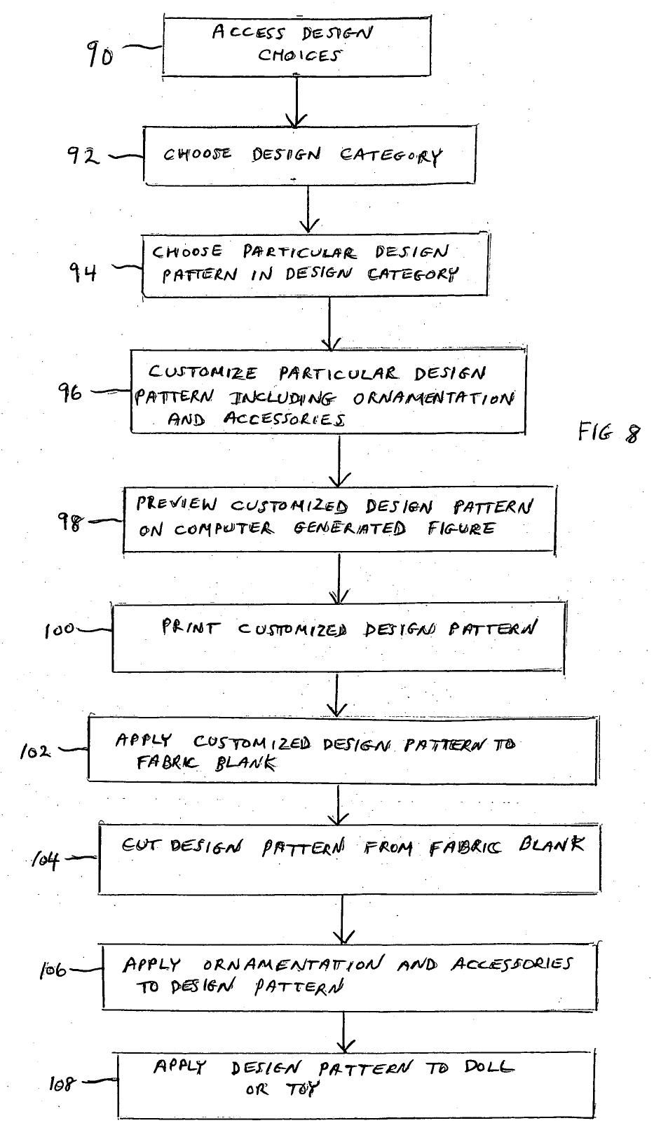

Regardless of the print medium 20 utilized, when the dress design is printed, it would be in a flat two-dimensional state. The present invention could include a kit which would be provided, for example, with a plurality of different blanks, as well as various implements for affixing accessories to the dress. Additionally, a number of marking pens or pencils may also be included. The kit would also be provided with one or more mannequins which could take the form of a doll or stuffed animal 80 shown in FIG. 7. If this was the case, the user would have the opportunity to design clothing 82 for the stuffed animal in the manner as previously described with respect to the dress 62.

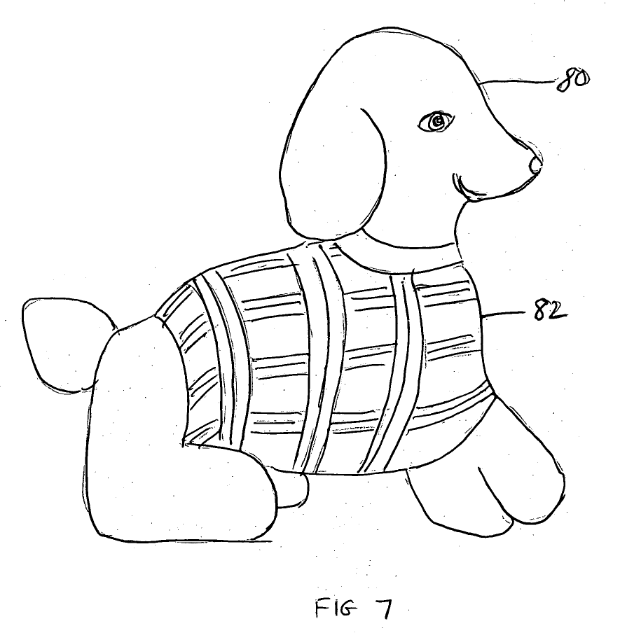

The two-dimensional pattern printed by the printer is then attached in some manner to one of the blanks, such as by glue or paste. The pattern is then cut from the blank by the user employing a pair of scissors or similar implement. Alternatively, the pattern can be traced upon the blank, at which point the pattern is cut from the blank. The user would then have the opportunity to apply the various colors, ornamentations and accessories directly to the pattern applied to or cut from the blank. The positioning of the accessories, coloring and ornamentation would be provided on the pattern as it is printed from the printer 20. Alternatively, the pattern could still be provided on the monitor screen 16 as shown in FIG. 4 or 5. If this is the case, the various ornamentations, coloring and accessories would be shown thereon, thereby allowing the user to properly apply these different features to the dress pattern. Once all of the ornamentation, coloring and accessories are applied to the dress pattern 62, the back seam of the dress is glued onto itself to create a three-dimensional dress pattern which would be applied to the mannequin shown in FIG. 6 which would include a vertical rod 70 directly attached to a base unit 72. Alternatively, the pattern can be applied to a paper-like doll.

It is further noted that the kit could include various implements for affixing various ornamentations or accessories to the basic dress pattern. For example, if the ornamentation and accessories included various beaded portions, an implement including variously colored beads could be provided. This implement would act as a dispenser for dispensing beads to various portions on the dress pattern, to which glue or a similar adherent has been directly applied. Additionally, the kit could also include various of the accessories, such as ruffles, fur or the like, as well as marking devices for coloring the pattern.

The method of creating a particular design, such as a dress to be applied to a mannequin is illustrated in FIG. 8. As previously described, the initial design methodology would be utilized with a computer. The computer would contain a removable memory provided with both an applications program as well as an operations program, the applications program containing a myriad number of design types as well as alterations and additions to the various design types. The use of a removable memory device would allow the user to obtain updated versions of the design types and modifications thereof. Alternatively, the user's computer could be connected to an online service which would include the various design choices. The user would then be connected to the online service through the use of the internet.

Once the applications memory is inserted into the computer and the computer is initialized, or connected to a remote memory, the user can access various design choices at step 90. These design choices would include the specific type of clothing, such as dresses, swimsuits, shirts, skirts, pants and the like. The user would be presented with a menu containing these grouping of design choices, or, in the alternative, these design categories would be pictorially projected onto the computer screen. At this point, the user would then choose one of the design categories at step 92. Once this is accomplished, a second menu would be presented allowing the user to alter the design of the particular piece of clothing chosen at step 94. Subsequently, various other menus can be presented to the user allowing the user to customize the particular design including the addition of ornamentation and accessories at step 96. These additions would also include choosing a color or colors for the piece of clothing. Once this step has been completed, the user, at step 98, would have the ability to preview the customized design pattern on a computer generated figure shown at step 98. The user would also at this step as well as at step 96 have the ability of changing the design choices that he or she made.

Once the customized design pattern is completed, the user would then print this customized design pattern at step 100. The printed pattern could include all of the ornamentation and accessories chosen by the user at step 96, including the chosen color or colors. Alternatively, a “bare bones” design would be printed, with the design including various portions to which ornamentation and accessories would be applied by the user utilizing various accessories such as beads, fur and ruffles included in the kit. Once this step has been completed, the customized design pattern would then be applied to a fabric blank at step 102. This application step could include physically adhering the customized design pattern to the fabric blank through the use of glue or paste. Alternatively, particularly if the printed pattern is bereft of most of the ornamentation and accessories, the user would have the opportunity of tracing the design pattern onto the fabric blank and cutting the pattern from the fabric blank at step 104. At this point, the user would also have the opportunity to apply the ornamentation and accessories to the design pattern at step 106. Once this is accomplished, the completed design pattern would be applied to a doll, toy or similar structure at step 108.

Both the customized design pattern, as well as the “bare bones” design would be applied to variable forms including, but not limited to, mannequins, stuffed animals, as well as paper dolls.

The present invention has been described with respect to the drawings describing a kit for allowing a user to design a pattern of clothes to be applied to a doll, stuffed animal or the like. It will be readily apparent to those skilled in the art that various changes and modifications of an obvious nature may be made without departing from the spirit of the invention, and all such changes and modifications are considered to fall within the scope of the present invention as defined by the appended claims.

What is claimed is:

1. A system for designing clothes to be applied to an inanimate object, comprising:
a computer provided with a display monitor;
a memory in communication with said computer, said memory containing a plurality of clothing patterns, as well as a plurality of alterations to be made to each of said clothing patterns, wherein said plurality of clothing patterns, as well as said plurality of alterations displayed on said display monitor;
a printer connected to said computer for printing a clothing pattern based upon choices made by a user; and
an inanimate object to which said completed clothing pattern is applied.

2. The system in accordance with claim 1, further including an input device for displaying one of a plurality of basic clothing patterns on said display, said input device enabling a user to alter said basic clothing pattern by changing various parameters of said basic clothing pattern.

3. The system in accordance with claim 2, wherein said input device would enable a user to add various design elements to said basic clothing pattern, which would be displayed on said display monitor.

4. The system in accordance with claim 2, wherein said input device would enable a user to add accessories to said basic clothing pattern, which would be displayed on said display monitor.

5. The system in accordance with claim 4, wherein said accessories include beading.

6. The system in accordance with claim 2, wherein said input device enables a user to designate the color of at least a portion of said basic clothing pattern to be displayed on said display monitor.

7. The system in accordance with claim 1, wherein said printed clothing pattern is a partial pattern containing only a limited number of alterations chosen by the user.

8. The system in accordance with claim 5, wherein said printed clothing pattern is a partial pattern containing only a limited number of alterations chosen by the user.

9. The system in accordance with claim 8, wherein said partial pattern indicates the position to which said beading is to be applied.

10. The system in accordance with claim 9, further including an implement to apply said beading.

11. The system in accordance with claim 7, wherein said partial pattern indicates the color to be applied to said partial pattern.

12. The system in accordance with claim 11, further including a plurality of marking devices to color said partial pattern.

13. The system in accordance with claim 7, further including a plurality of cloth blanks to which said partial pattern is applied, prior to being applied to said inanimate object.

14. The system in accordance with claim 1, further including a digital camera in communication with said computer for capturing an image of the user's face to be displayed with a figure projected on said display monitor, modeling said clothing pattern based upon choices made by said user.

15. The system in accordance with claim 1, wherein said inanimate object is a doll.

16. The system in accordance with claim 1, wherein said inanimate object is a stuffed animal.

17. The system in accordance with claim 1, wherein said printer would print a plurality of clothing patterns, compiled as a portfolio.

18. A method of designing clothes to be applied to an inanimate object including the stages of:
a) inputting a plurality of clothing patterns as well as a plurality of alterations to be made to each of said clothing patterns in a computer having a display monitor;
b) choosing a designated clothing pattern to be projected onto said display monitor;
c) customizing said designated clothing pattern displayed on said display monitor utilizing at least one of said alterations;
d) displaying said clothing pattern produced by step c) on said display monitor;
e) printing said clothing pattern displayed in step d); and
f) applying said clothing pattern printed in step e) to an inanimate object.

19. The method in accordance with claim 18, further including the steps of:
digitally capturing the image of the user's face; and
displaying said designated clothing pattern on a figure projected upon said display screen, said figure including the captured image of the user's face.
